(19) United States
(12) Patent Application Publication
(10) Pub. No.: US 2014/0189643 A1
(43) Pub. Date: Jul. 3, 2014

(54) METHODS FOR CREATING AND PROVIDING A VIRTUAL ENVIRONMENT AND DEVICES THEREOF

(71) Applicant: Wipro Limited, Bangalore (IN)

(72) Inventors: Sriraman Kandhadai Raghunathan, Bangalore (IN); Giridhara Madhakashira, BEGUR HOBLI (IN)

(21) Appl. No.: 13/857,482

(22) Filed: Apr. 5, 2013

(30) Foreign Application Priority Data
Jan. 2, 2013 (IN) 446/CHE/2013

(51) Int. Cl. G06F 9/44

(52) U.S. Cl. CPC G06F 8/70
USPC 717/120

(57) ABSTRACT

A method, non-transitory computer readable medium, and an environment manager computing device comprises receiving at least one selection of one or more environments from a client computing device. An environment definition document associated with the selected one or more environments are obtained. Next, a virtual environment for the selected one or more environments is created based on the obtained environment definition document. Finally, the created virtual environment is provided to the requesting client computing device.

This application claims the benefit of Indian Patent Application Filing No. 446/CHE/2013, filed Jan. 2, 2013, entitled “METHODS FOR CREATING AND PROVIDING A VIRTUAL ENVIRONMENT AND DEVICES THEREOF,” which is hereby incorporated by reference in its entirety.

### FIELD

This technology generally relates to software development, more particularly, to methods for creating and providing a virtual environment and devices thereof.

### BACKGROUND

A software development life cycle is a structure imposed on the development of a software product. The software development life cycle includes two major phases which are development and testing. Due to the rapidly changing technology, there is a requirement to adapt the development and testing environment to facilitate development of superior software solutions. Additionally, there is a requirement to setup an environment to train personnel on using these superior software solutions and also give a demonstration of the software solutions.

Unfortunately, existing technologies for creating environments for training, demonstration, development or testing can consume significant resources and personnel of an organization. Additionally, these existing technologies can be inefficient because a substantial amount of user intervention may be required making the process of training, demonstration, development or testing expensive and less productive.

### SUMMARY

A method for creating and providing a virtual environment includes receiving by an environment manager computing device at least one selection of one or more environments from a client computing device. An environment definition document associated with the selected one or more environments is obtained by the environment manager computing device. A virtual environment for the selected one or more environments is created based on the obtained environment definition document by the environment manager computing device. The created virtual environment is provided to the requesting client computing device by the environment manager computing device.

A non-transitory computer readable medium having stored thereon instructions for creating and providing a virtual environment comprising machine executable code which when executed by at least one processor, causes the processor to perform steps including receiving at least one selection of one or more environments from a client computing device. An environment definition document associated with the selected one or more environments are obtained. Next, a virtual environment for the selected one or more environments is created based on the obtained environment definition document. Finally, the created virtual environment is provided to the requesting client computing device.

An environment manager computing device comprising one or more processors, a memory, wherein the memory coupled to the one or more processors which are configured to execute programmed instructions stored in the memory including receiving at least one selection of one or more environments from a client computing device. An environment definition document associated with the selected one or more environments are obtained. Next, a virtual environment for the selected one or more environments is created based on the obtained environment definition document. Finally, the created virtual environment is provided to the requesting client computing device.

This technology provides a number of advantages including providing more effective methods, non-transitory computer readable medium and devices for creating and providing a virtual environment for applications, such as training, demonstration, development or testing. Particularly, the technology disclosed in this application completely automates the process of setting up virtual environments for training, demonstration, development or testing using the environment definition language document. Additionally, by using the exemplary methods illustrated, virtual environments with real-life scenarios can be easily created using the environment definition language document. Accordingly, the technology provides flexibility to quickly change the settings or configurations of the environment by simply changing the information present in the environment definition language document as opposed to manually changing each part of the virtual environment. Further, the technology also provides application programming interfaces using which the clients can easily modify or change the configurations or settings on the virtual environments.

### BRIEF DESCRIPTION OF THE DRAWINGS

FIG. 1 is a block diagram of an exemplary environment with a environment manager computing device for creating and providing a virtual environment;

FIG. 2 is an exemplary functional block diagram of a plurality of modules present within a memory of the environment manager computing device;

FIGS. 3A-3B are flowcharts of an exemplary method for creating and providing a virtual environment;

FIG. 4 is an exemplary illustration of contents of an environment definition language document; and

FIG. 5 is an exemplary representation of a created virtual environment.

### DETAILED DESCRIPTION

An exemplary environment 10 with an environment manager computing device 14 for creating and providing a virtual environment is illustrated in

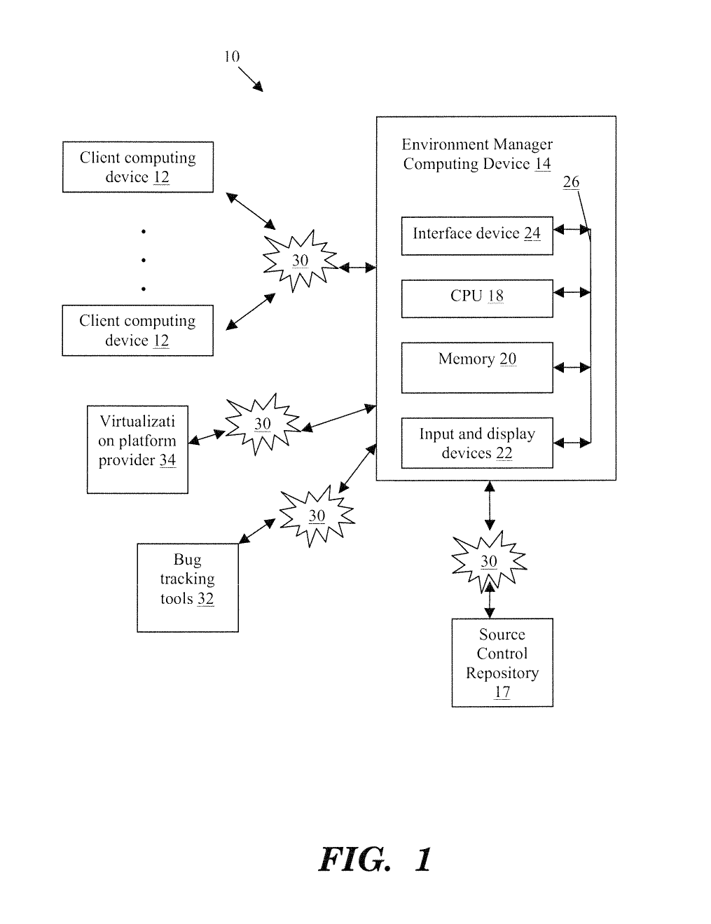

FIG. 1. The exemplary environment 10 includes plurality of client computing devices 12, the environment manager computing device 14, and the source control repository 17, bug tracking tools 32 and the virtualization platform provider 34 which are coupled together by a communication network 30, although the environment can include other types and numbers of devices, components, elements, and communication networks 30 in other topologies and deployments. While not shown, the exemplary environment 10 may include additional components, such as database etc, which are well known to those of ordinary skill in the art and thus will not be described here. This technology provides a number of advantages including providing more effective methods, non-transitory computer readable medium and devices for creating and providing a virtual environment for applications, such as training, demonstration, development or testing.

Referring more specifically to FIG. 1, environment manager computing device 14 is coupled to client computing devices 12 through the communication network 30, although the client computing devices 12 and environment manager computing device 14 may be coupled together via other topologies. As it would be appreciated by a person having ordinary skill in the art, the communication network 30 can include one or more of a local area network (LAN) or a wide area network (WAN), although the communication network 30 can include any other topologies. Additionally, the environment manager computing device 14 is coupled to the source control repository 17, the bug tracking tools 32 and the virtualization platform provider 34 through the communication network 30, although the source control repository 17, bug tracking tools 32, the virtualization platform provider 34 and environment manager computing device 14 may be coupled together via other topologies.

The environment manager computing device 14 assists with creating and providing a virtual environment as illustrated and described with the examples herein, although environment manager computing device 14 may perform other types and numbers of functions. The environment manager computing device 14 includes at least one CPU/processor 18, memory 20, input and display devices 22, and interface device 24 which are coupled together by bus 26, although environment manager computing device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

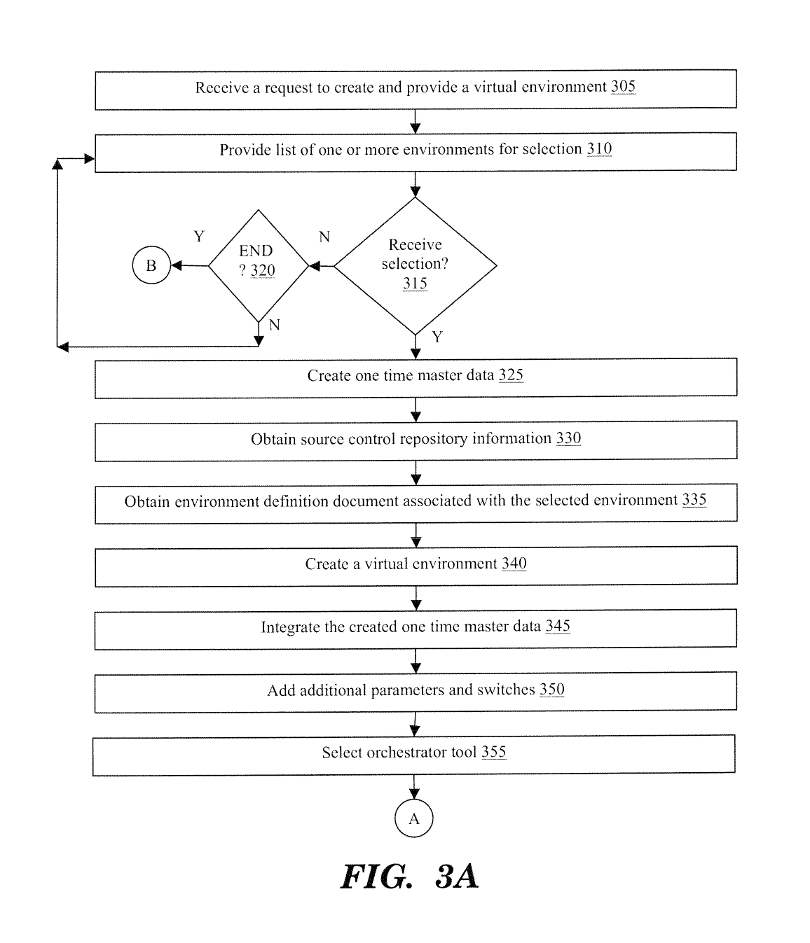

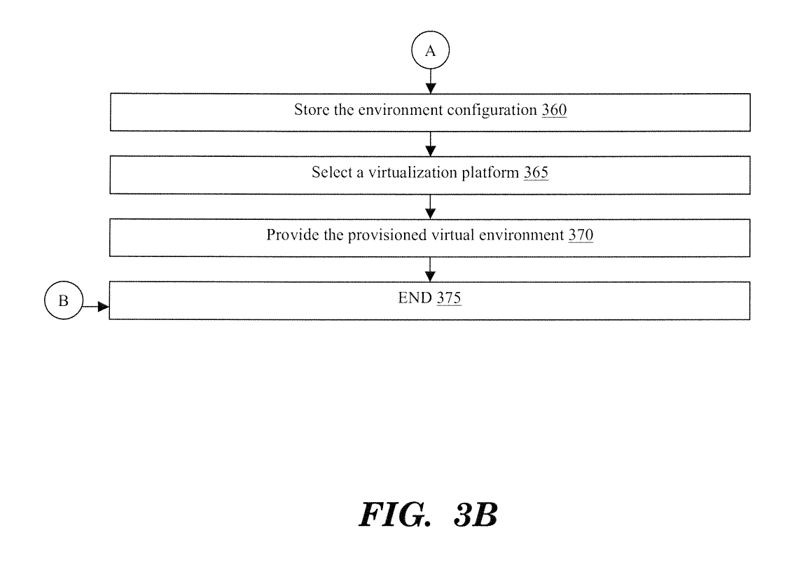

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more non-transitory computer-readable instructions of this technology as illustrated and described with reference to the examples herein that may be executed by the one or more processor(s) 18. The flow chart shown in FIG. 3A-3B is representative of example steps or actions of this technology that may be embodied or expressed as one or more non-transitory computer or machine readable instructions stored in memory 20 that may be executed by the processor(s) 18.

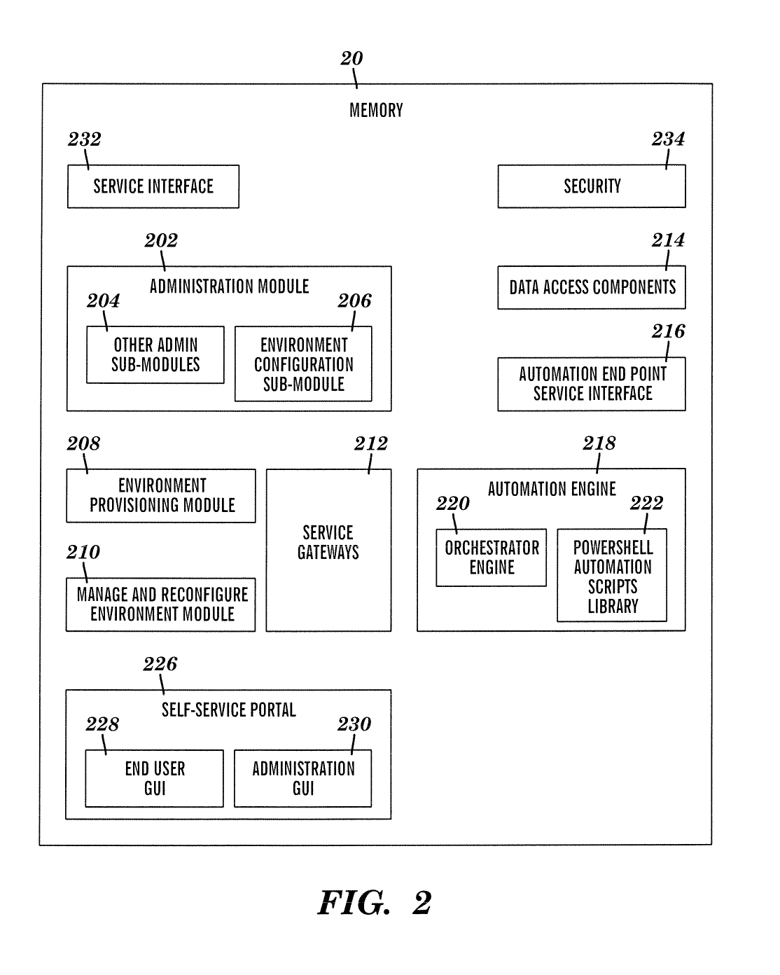

Further, as illustrated in FIG. 2, the memory 20 further includes an administration module 202 comprising other administration sub-modules 204, environment configuration sub-module 206 within the administration module 202, although the memory can include other types and numbers of modules, programs, instructions and/or data. Additionally, the memory 20 includes an environment provisioning module 208, manage and reconfigure environment module 210, service gateways 212, data access components 214, and an automation and point service interface 216. Further, the memory 20 includes an automation engine 218 comprising an orchestrator engine 220, and a powershell automation scripts library 222. Furthermore, the memory 20 includes a self-service portal 226 including end user GUI 228 and an administration GUI 230. The memory 20 also includes a service interface 232 and a security 234 as illustrated in FIG. 2, although the memory 20 can include any other modules to assist with creating and providing a virtual environment. The modules present within the memory 20 assist with creating and providing a virtual environment, although the modules can assist for carrying out any other steps.

As illustrated in FIG. 2, the administration module 202 includes the other admin sub-modules 204 and the environment configuration sub-modules, although the administration module 202 can include any other modules. The other admin sub-modules 204 assists with the master data management such as users of the system, their roles, projects, applications and their versions, training and demo master data, although the admin sub-modules 204 can assist by performing any other functions.

Next, the environment configuration sub-module 206 assist with retrieving an appropriate environment definition language (EDL) XML file and other details including the orchestrator identifier from the database through the data access components 214, although the environment provisioning module 208 can perform any other functions.

Particularly, the environment provisioning module 208 assists with invoking the specific service gateway integration adapter that will further integrate to the specified underlying orchestrator tool through a service communication channel or any other means as required by the orchestrator tool using a retrieved orchestrator identifier will then invoke the specific service gateway integration adapter that will further integrate to the specified. Further, the environment configuration sub-module 206 will send the appropriate parameters and the EDL XML file to the appropriate orchestrator service gateway 212 integration adapters that will further invoke the runbook or workflow defined in the external orchestrator tool and transmits the EDL XML file and other parameters. It should be appreciated that the name of the workflow or runbook to be invoked will be specified in the EDL XML file itself.

Manage and reconfigure environment module 210 assist with reconfiguration of an already provisioned virtual environment such as re-deployment of an application to a different version, modifying the chapter in a training module and retrieving an appropriate environment definition language (EDL) XML file and other details including the orchestrator identifier from the database through the data access components, although manage and reconfigure environment module 210 can perform any other operations. Additionally, the manage and reconfigure environment module 210 may also assist with invoking the specific service gateway integration adapter that will further integrate to the specified underlying orchestrator tool through a service communication channel or any other means as required by the orchestrator tool using a retrieved orchestrator identifier will then invoke the specific service gateway integration adapter that will further integrate to the specified. Further, the environment configuration sub-module 206 will send the appropriate parameters and the EDL XML file to the appropriate orchestrator service gateway 212 integration adapters that will further invoke the runbook or workflow defined in the external orchestrator tool and transmits the EDL XML file and other parameters.

Next, the service gateways 212 assist with integrating with various external toolsets like source control repositories 17, bug tracking tools and other software development lifecycle tools, although the service gateways 212 can perform any other operations. Additionally, the service gateways 212 may also assists with integrating to the orchestrator based automation engine and underlying virtualization platforms. The gateways provide a gateway façade using which the underlying integration gateways are abstracted thus providing the facility to integrate with various external toolsets without the need for modifying the underlying code base.

The data access components 214 assist with accessing the underlying data store for performing data retrieval and updates, although the data access components 214 can perform any other operations.

Automation and point service interface 216 assists with encapsulating the automation engine and makes itself accessible to the other modules using its service interface API for receiving and sending the EDL XML file and other parameters from the environment provisioning and reconfiguration module, although the automation and point service interface 216 can perform any other operations.

Further, the automation engine 218 includes an orchestrator engine 220 and a powershell scripts library 222, although the automation engine 218 can include any other modules or sub-modules. Generally the automation engine 218 assist with automating the provisioning and configuration of virtual environments, although the automation engine 218 can perform any other operations. The orchestrator engine 220 assists with automating the provisioning and configuration of virtual environments by defining a set of configurable work books, although the orchestrator engine 220 can perform other functions. The powershell automation scripts library 222 assists with providing programmatic control of the automation process and steps like building application, deploy and configure scripts, pre and post environment setup steps, although the powershell automation scripts library 222 can perform other operations. By way of example only, the powershell automation scripts library 222 further invoke and integrate with the appropriate APIs of external toolsets like source code control repositories 17, virtualization platforms. Additionally, the powershell automation scripts library 222 scripts also include a ready template of application build and deploy scripts and the powershell automation scripts library 222 are invoked by the orchestrator workbooks.

Furthermore, the self-service portal 226 includes an end user GUI module 228 and an administration GUI 230, although the self-service portal 226 can include any other modules. The self-service portal 226 in general assist with providing a web based self-service capabilities to the end user to create and manage virtual environment definitions and to provision and manage those virtual environments, although the self-service portal 226 can perform any other operations. Particularly, the end user GUI 228 assist with providing self-service capabilities to provision the virtual environments, re-configure the provisioned virtual environments, share and release the environments to other users and create and manage snapshots of those virtual environments. Further, the administration GUI 230 assist with providing self-service capabilities to lab administrator for managing master data, creating and configuring environment definitions, managing users and roles.

The service interface 232 within the memory 20 assists with providing a set of APIs for enabling custom user interfaces to be built for providing end users a self-service capability to use the automation framework, although the service interface 232 can perform any other operations. The service interface also assists in providing a API for use by the automation engine.

The security module 234 present within the memory 20 assists with providing an authentication and authorization mechanism between the self-service portal and the automation framework, although the security module 234 can perform any other operations.

Input and display devices 22 enable a user, such as an administrator, to interact with the environment manager computing device 14, such as to input and/or view data and/or to configure, program and/or operate it by way of example only. Input devices may include a keyboard and/or a computer mouse and/or touch screen devices and display devices may include a computer monitor and/or touch screen devices, although other types and numbers of input devices and display devices could be used.

The interface device 24 in the environment manager computing device 14 is used to operatively couple and communicate between the environment manager computing device 14, the client computing devices 12, and the source control repository 17 which are all coupled together by the communication network 30, although other types and numbers of communication networks 30 or systems with other types and numbers of connections and configurations to other devices and elements. By way of example only, the communication network 30 can use TCP/IP over Ethernet and industry-standard protocols, including NFS, CIFS, SOAP, XML, LDAP, and SNMP, although other types and numbers of communication networks, can be used. In this example, the bus 26 is a hyper-transport bus in this example, although other bus types and links may be used, such as PCI.

Each of the client computing devices 12, and the source control repository 17 include a central processing unit (CPU) or processor, a memory, an interface device, and an I/O system, which are coupled together by a bus or other link, although other numbers and types of network devices could be used. The client computing devices 12, in this example, may run interface applications to access the virtual environment provided by the environment manager computing device 14 via communication network 30, although any other applications may execute on the client computing device 12. By way of example only, the client computing device 12 can access the virtual environment created by the environment manager computing device 14 using a remote desktop active X control programs.

The source control repository 17 stores the software code required for creating the virtual environment and the environment manager computing device 14 obtains the software code from the source control repository 17 while creating the virtual environment. By way of example only, the source control repository 17 in this example can be an apache subversion (SVN) or team foundation server (TFS) source control repository.

Next, the bug tracking tools 32 assists with resolving errors occurred while creating the virtual environment, although the bug tracking tools 32 can perform any other operations. Accordingly, if the environment manager computing device 14 identifies any problems/errors while creating the virtual environment, the environment manager computing device 14 obtains the necessary information from the bug tracking tools 32 to resolve the identified issues.

Further, the virtualization platform provider 34 provides the platform in terms of the number of processors or memory devices to create the virtual environment, although the virtualization platform provider 34 may provide any other functions. In this example, the environment manager computing device 14 selects the virtualization platform to provision the virtual environment from the virtualization platform provider 34, although the environment manager computing device 14 can select the virtualization platform from any other location including the memory 20.

Although an exemplary network environment 10 with the client computing devices 12, the environment manager computing device 14, the source control repository 17, bug tracking tools 32, the virtualization platform provider and the communication network 30 are described and illustrated herein, other types and numbers of systems, devices, blades, components, and elements in other topologies can be used. It is to be understood that the methods of the examples described herein are for exemplary purposes, as many variations of the specific hardware and software used to implement the examples are possible, as will be appreciated by those skilled in the relevant art(s).

Furthermore, each of the methods of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

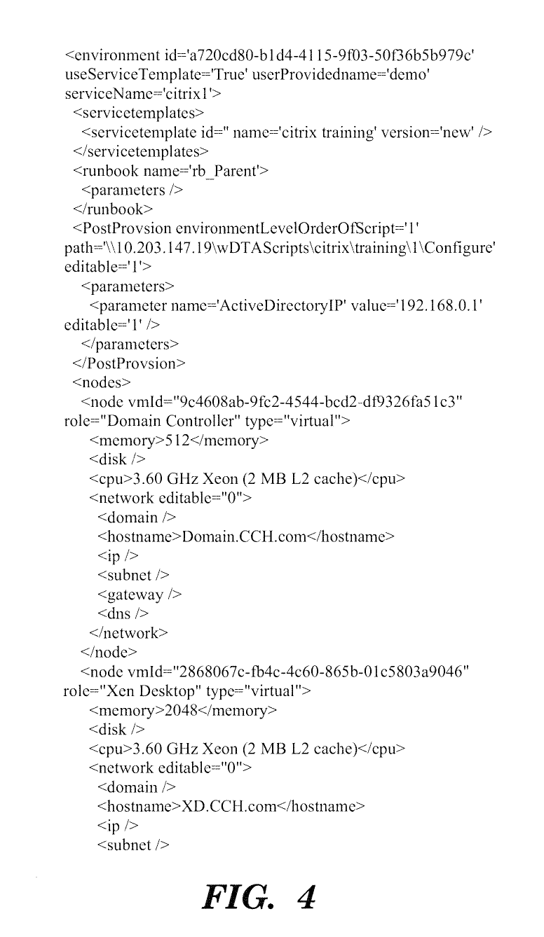

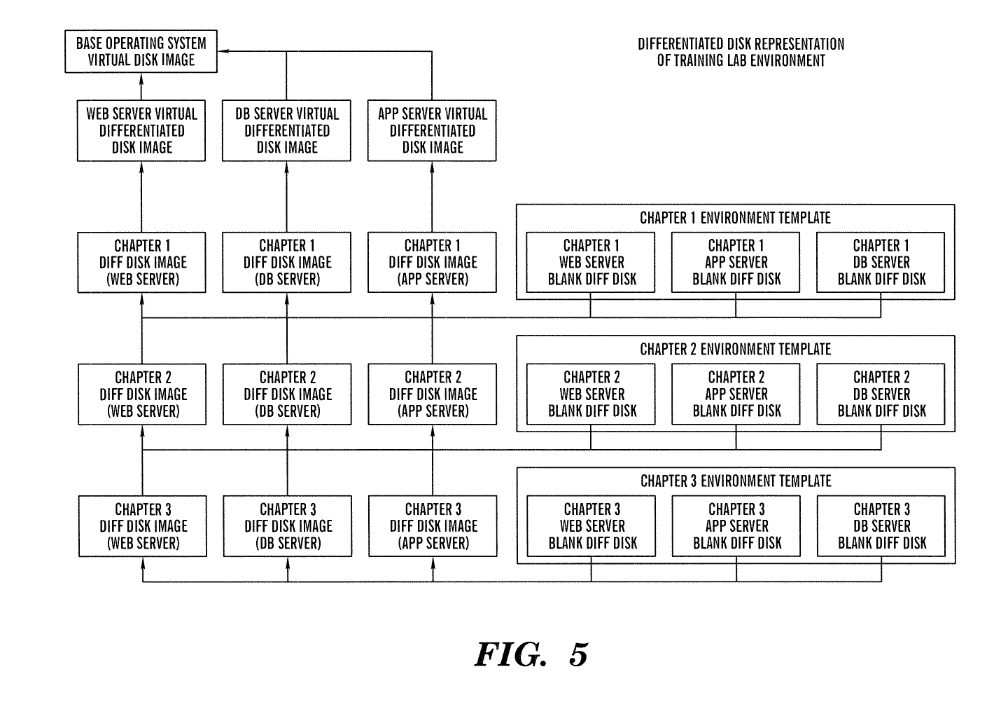

An exemplary method for creating and providing virtual environment will now be described with reference to FIGS. 1-5. The exemplary methods beings at step 305 with the environment manager computing device 14 receiving a request to create a virtual environment from a client computing device 12, although the environment manager computing device 14 can receive any other types or amounts of requests from any other devices.

Next, in step 310, the environment manager computing device 14 provides a list of the environments to the requesting client computing device 12 as a response to the request, although the environment manager computing device 14 can provide any additional information along with the list of environments. By way of example only, the list of environments includes a training lab environment, a demonstration lab environment and development or testing lab environment, although the list provided by the environment manager computing device 14 can provide the list including any additional types of environment.

In step 315, the environment manager computing device 14 determines if the requesting client computing device 12 selected at least one of the environments provided step 310. By way of example only, the environment manager computing device 14 would receive a notification of the environment that the requesting client computing device 12 selected. However, after waiting for a certain period of time, if the environment manager computing device 14 determines that the client computing device 12 has not selected any of the listed environments, then the No branch is taken to step 320.

In step 320, the environment manager computing device 14 determines if the requesting client computing device 12 wants to proceed further by providing two options: a Yes option and a No option. If the environment manager computing device 14 receives a selection of the No option, the flow of the exemplary process goes back to step 310 where the list of the environments is provided again by the environment manager computing device 14. However, if the received selection is a Yes option, then the flow of the exemplary process proceeds to step 375 where the exemplary process ends.

If back in step 315, after waiting for a certain period of time the environment manager computing device 14 determines that the client computing device 12 has selected one of the listed environments, then the Yes branch is taken to step 325. In this example, the environment manager computing device 14 receives a selection to create a training lab environment from the client computing device 12.

In step 325, the environment manager computing device 14 creates a one time master data for the received selection of the environment, although the environment manager computing device 14 can create any additional information as a response to receiving the selection. As it would be appreciated by a one of ordinary skill in the art, the one time master data in this example relates to creating real scenario projects, training courses, chapters or demonstration story collection, although the one time master data can create any additional amounts of data. In this example, the environment manager computing device 14 creates a one time master data including all the training modules, chapters, sections and sub-sections for the training environment.

Next in step 330, the environment manager computing device 14 obtains information such as a source code from the source control repository 17 using an identifier associated with the selected environment, although any other information could be obtained from the source control repository 17. When the environment manager computing device 14 receives a selection of the environment, the environment manager computing device 14 also receives an identifier along with the selection. In this step 330, the environment manager computing device 14 obtains the relevant information from the source control repository using the identifier, although the environment manager computing device 14 can obtain the relevant information from the source control repository 17 using any other techniques. In this example, the environment manager computing device 14 proceeds to obtain the source code associated with the training environment from the source control repository 17.

In step 335, the environment manager computing device 14 obtains an environment definition language document associated with the received selection of the environment from the memory 20 present within the environment manager computing device 14, although the environment manager computing device 14 can obtain the environment definition language document from any other memory location. An exemplary environment definition language document is illustrated in FIG. 3. As it would be appreciated by one of ordinary skill in the art, the environment definition language document includes information relating to the total number of virtual machines required to create the virtual environment for the selected environment, the configurations of the virtual machines and information relating to the communication between the virtual machines used to create the virtual environment, although the environment definition language document can include any amounts of additional information. In this example, the environment definition language document is in an extensible markup language (XML) format, although the environment definition language document can be in any other format. In this example, the environment manager computing device 14 obtains an environment definition language document from memory 20 associated with the training environment.

In step 340, the environment manager computing device 14 creates a virtual environment for the selected environment using the environment definition language document, although the environment manager computing device 14 can create the virtual environment for the selected environment using any other additional information. By way of example only, creating a virtual environment relates to using the information present in the environment definition language document to create virtual images of the selected environment on virtual machines and configuration interaction among the created virtual machines. In this example, the environment manager computing device 14 creates a training lab virtual environment including using the information present in the environment definition language document.

Next, in step 345, the environment manager computing device 14 integrates the one time master data created in step 325 on to the created virtual environment. As it would be appreciated by a person having ordinary skill in the art, the environment manager computing device 14 adds the created real scenario projects, training courses, chapters or demonstration story collection to the virtual environment so that created virtual environment is very similar to an actual scenario of the environment. In this example, the environment manager computing device 14 integrates the previously created training modules, chapters, sections and sub-sections to the created training virtual environment.

In step 350, the environment manager computing device 14 configures the created virtual environment by adding additional parameters and switches to the created virtual environment. By way of example only, adding of additional parameters and switches relates to configuring the created virtual environment to restrict the users who can access the created environment, configuring the usability permissions of user using the environment, although the created virtual environment can be configured for any other settings. In this example, the environment manager computing device 14 configures the created virtual environment to add privileges such as providing an administrator to read, write or modify the content and providing any other users other than the administrator only with read permission for the modules created in the training lab virtual environment.

In step 355, the environment manager computing device 14 further configures the created virtual environment by selecting an orchestrator tool relevant to the created virtual environment from the memory 20, although the environment manager computing device 14 can select the orchestrator engine and the virtualization toolset for the created virtual environment from any other locations. The orchestrator tool for the created virtual environment assists with automating the workflows in the created virtual environment, although orchestrator tool can provide any additional functions. In this example, the environment manager computing device 14 proceeds to select an orchestrator tool relevant to the training lab virtual environment from the memory 20. In this example, the orchestrator tool configures the workflow in the created training lab virtual environment.

In step 360, the environment manager computing device 14 stores the configuration of the created virtual environment within the memory 20, although the environment manager computing device can store the configurations of the created virtual environment at any other location. In this example, the environment manager computing device 14 stores the configuration of the training lab virtual environment within the memory 20.

In step 365, the environment manager computing device 14 selects a virtualization platform to provision the created virtual environment from the virtualization platform provider 34, although the environment manager computing device 14 can select the virtualization platforms stored within the memory 20. By way of example only, the environment manager computing device 14 selects the virtualization platform to provision the created virtual environment based on the number of virtual machines which in present within the environment definition language document, although the environment manager computing device 14 can select the virtualization platform using any other techniques. In this example, the environment manager computing device 14 proceeds to select a virtualization platform to provision the created training lab virtual environment. The environment manager computing device 14 selects the training lab virtual environment based on the information present in the environment definition language document, particularly number of virtual machines required, the interaction among the virtual machines and also the workflow in the virtual environment.

In step 370, the environment manager computing device 14 provides the provisioned virtual environment to the requesting client computing device 12 via a graphical user interface, although the environment manager computing device 14 can provide the provisioned virtual environment to the requesting client computing device 12 using any other techniques. An exemplary, provisioned virtual environment including multiple virtual machines is illustrated in FIG. 6. Additionally, the environment manager computing device 14 provides multiple application programming interfaces to the requesting client computing device 12 to modify the created virtual environment. By way of example only, using the application programming interfaces, the client computing device 12 can de-provision the provisioned virtual environment, although the client computing devices 12 can perform any other operations using the application programming interfaces provided by the environment manager computing device 14. In this example, the environment manager computing device 14 provisions the created training lab virtual environment on the selected virtualization platform and provides the created training lab virtual environment to the requesting client computing device 12. The exemplary process ends at step 375.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for creating and providing a virtual environment comprising:
receiving by an environment manager computing device at least one selection of one or more environments from a client computing device;
obtaining by the environment manager computing device an environment definition document associated with the selected one or more environments;
creating by the environment manager computing device a virtual environment for the selected one or more environments based on the obtained environment definition document; and
providing by the environment manager computing device the created virtual environment to the client computing device.

2. The method as set forth in claim 1 wherein the creating further comprises:
selecting by the environment manager computing device an orchestrator tool for the created virtualization environment
configuring by the environment manager computing device the virtual environment based on the selected orchestrator tool; and
provisioning by the environment manager computing device the configured virtual environment on a virtualization platform prior to the providing.

3. The method as set forth in claim 1 wherein the providing further comprises providing by the environment manager computing device a graphical user interface to the client computing device to access the created virtual environment.

4. The method as set forth in claim 1 further comprising providing by the environment manager computing device an application programming interface via the graphical user interface to the client computing device to modify the created virtual environment.

5. The method as set forth in claim 1 further comprising:
creating by the environment manager computing device a master data for the created virtual environment;
obtaining by the environment manager computing device a source repository information;
using by the environment manager computing device the created master data and the obtained source repository information to create the virtual environment.

6. The method as set forth in claim 1 wherein the obtained environment definition document comprises one or more of a number of virtual machines to be created, one or more rules for interaction among the virtual machines, or one or more other metadata related information.

7. A non-transitory computer readable medium having stored thereon instructions for creating and providing a virtual environment comprising machine executable code which when executed by at least one processor, causes the processor to perform steps comprising:
receiving at least one selection of one or more environments from a client computing device;
obtaining an environment definition document associated with the selected one or more environments;
creating a virtual environment for the selected one or more environments based on the obtained environment definition document; and
providing the created virtual environment to the client computing device.

8. The medium as set forth in claim 7 wherein the creating further comprises:
selecting an orchestrator tool for the created virtualization environment
configuring the virtual environment based on the selected orchestrator tool; and
provisioning the configured virtual environment on a virtualization platform prior to the providing.

9. The medium as set forth in claim 7 wherein the providing further comprises providing a graphical user interface to the client computing device to access the created virtual environment.

10. The medium as set forth in claim 7 further comprising providing an application programming interface via the graphical user interface to the client computing device to modify the created virtual environment.

11. The medium as set forth in claim 7 further comprising:
creating a master data for the created virtual environment;
obtaining a source repository information;
using the created master data and the obtained source repository information to create the virtual environment.

12. The medium as set forth in claim 7 wherein the obtained environment definition document comprises one or more of a number of virtual machines to be created, one or more rules for interaction among the virtual machines, or one or more other metadata related information.

13. An environment manager computing device comprising:
one or more processors;
a memory, wherein the memory coupled to the one or more processors which are configured to execute programmed instructions stored in the memory comprising:
receiving at least one selection of one or more environments from a client computing device;
obtaining an environment definition document associated with the selected one or more environments;
creating a virtual environment for the selected one or more environments based on the obtained environment definition document; and
providing the created virtual environment to the client computing device.

14. The device as set forth in claim 13 wherein the one or more processors is further configured to execute programmed instructions stored in the memory for the creating further comprises:
selecting an orchestrator tool for the created virtualization environment
configuring the virtual environment based on the selected orchestrator tool; and
provisioning the configured virtual environment on a virtualization platform prior to the providing.

15. The device as set forth in claim 13 wherein the one or more processors is further configured to execute programmed instructions stored in the memory for the providing further comprises providing a graphical user interface to the client computing device to access the created virtual environment.

16. The device as set forth in claim 13 wherein the one or more processors is further configured to execute programmed instructions stored in the memory further comprising providing an application programming interface via the graphical user interface to the client computing device to modify the created virtual environment.

17. The device as set forth in claim 13 wherein the one or more processors is further configured to execute programmed instructions stored in the memory further comprising:
creating a master data for the created virtual environment;
obtaining a source repository information;
using the created master data and the obtained source repository information to create the virtual environment.

18. The device as set forth in claim 13 wherein the obtained environment definition document comprises one or more of a number of virtual machines to be created, one or more rules for interaction among the virtual machines, or one or more other metadata related information.
